(19) United States
(12) Patent Application Publication
(10) Pub. No.: US 2026/0225739 A1
(43) Pub. Date: Aug. 6, 2026

(54) HEAT PIPE-BASED THERMAL CONTROL ARCHITECTURE FOR SPACECRAFT

(71) Applicant: Government of the United States as represented by the Secretary of the Air Force, Wright-Patterson AFB, OH (US)

(72) Inventor: Jonathan Allison, Albuquerque, NM (US)

(21) Appl. No.: 19/045,843

(22) Filed: Feb. 5, 2025

(51) Int. Cl. B64G 1/50; B64G 1/12

(52) U.S. Cl. CPC B64G 1/506; B64G 1/12

(57) ABSTRACT

A passive thermal control system for spacecraft. The system includes a spacecraft, the with a service module and a command module, wherein the command module comprises a pressurized space. A first heat pipe is disposed inside the pressurized space, the first heat pipe being thermally coupled to a second heat pipe outside the pressurized space. A third heat pipe is thermally coupled to the second heat pipe at the service module.

### TECHNICAL FIELD

The present disclosure relates to passive thermal control of spacecraft.

### BACKGROUND

Reliability is extremely difficult to accurately model and predict but is known to be inversely related to the number of components and number of interactions between those components. Reliability for mechanical systems is often determined by the number of mechanical moving parts. Thermal controls in spacecraft that rely on interactive, solid components are at risk of a relatively higher risk of failure compared to those with no moving solid parts.

There is a continuing unmet need for a thermal control architecture for spacecraft with increased reliability.

### BRIEF DESCRIPTION OF THE DRAWINGS

The following detailed description of embodiments of the present disclosure can be best understood when read in conjunction with the drawings enclosed herewith:

FIG. 1 is a schematic diagram of an example embodiment of a heat-pipe based thermal control architecture for spacecraft;

FIG. 2 is a schematic diagram of an example embodiment of a heat-pipe based thermal control architecture for spacecraft;

FIG. 3 is a schematic diagram of an example embodiment of a heat-pipe based thermal control architecture for a stowed surface rover;

FIG. 4 is a schematic representation of a surface rover;

FIG. 5 is schematic representation of a penetration-free thermal interface;

FIG. 6 is a cross-sectional view of Section 6-6 in FIG. 5;

FIG. 7 is a schematic view of an example loop heat pipe with flash evaporator;

FIG. 8 is a representative flexible heat pipe; and

FIG. 9 is a cross-sectional view of Section 9-9 in FIG. 8.

The embodiments set forth in the drawings are illustrative in nature and not intended to be limiting. Moreover, individual features of the drawings and the disclosure will be more fully apparent and understood in view of the detailed description.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific FIG. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

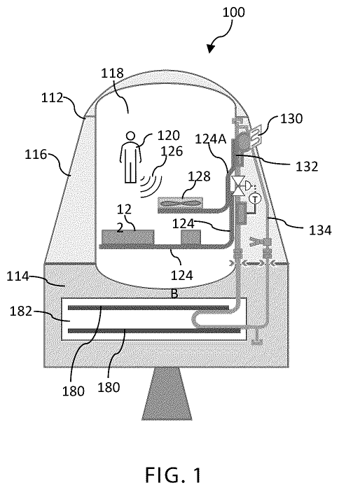

Referring to FIG. 1, there is shown an example embodiment of a heat-pipe based thermal control architecture for spacecraft 100 which can be, for example, a space capsule or a spaceplane, which is described herein as a passive thermal control system that includes a plurality of passive heat transfer apparatuses and a spacecraft 112. The spacecraft 112 can have a service module 114 and a command module 116 in which is a pressurized space 118 that can house persons 120 and equipment 122, such as electronics. The persons and equipment in the pressurized space 118 of the command module 116 can produce heat inside the pressurized space 118 that can be problematic if the temperature in the pressurized space 118 exceeds safe thresholds, either hot or cold.

Inside the pressurized space at least one human-safe heat pipe 124 can aid in heat transfer from both metabolic heat 126 from persons 120, and heat from equipment 122. A human-safe heat pipe is a heat pipe in which the materials, including the working fluid are safe for use around humans, particularly in a malfunction in which humans are exposed to the working fluid. In one embodiment, the human-safe heat pipe 124 can be comprised of an extruded grooved aluminum envelope with n-Perfluorohexane (nPFH) as the fluid. The aluminum envelope can utilize reentrant (Omega-shaped) grooves to provide sufficient static wicking height while providing the best possible heat transport capacity. In another embodiment, the human-safe heat pipe 124 can be comprised of a copper envelope with water as the working fluid and a gas-load to aid in controlled freeze/thaw conditions. Any of the exemplary heat pipes utilized can optionally include an evacuated dump tank at one end of the heat pipe with a rupture disk separating the dump tank from the active portion of the heat pipe. In the anomalous event that the heat pipe overpressures, the burst disk can rupture to provide additional volume to the heat pipe to prevent a dangerous rupture which could harm people nearby.

A plurality of human-safe heat pipes 124 can be utilized, each being included for dedicated thermal functions and purposes. For metabolic heat 126 from persons 120 in the pressurized space 118, e.g., the crew cabin, a cabin fan and heat sink 128 can be thermally coupled to a first human-safe heat pipe 124A. By “thermally coupled” as used herein is meant joined to facilitate heat transfer from one component to another. In an embodiment, coupling can be achieved by joining mating surfaces, bolting, screwing, adhering, or otherwise providing for a heat transfer interface for efficient and/or optimal heat transfer. The cabin fan can be any of known cabin fans suitable for part of a ventilation system in manned spacecraft. The heat sink can be any of known suitable heat sinks and can be a heat sink thermally coupled to the first human-safe heat pipe 124A. Equipment 122, including electronics, which in general can withstand higher temperatures than that desired for persons, can be thermally coupled in heat-conductive relationship to a second human-safe heat pipe 124B. Each of the plurality of heat pipes 124 can be mounted to one or more penetration free thermal interfaces 132. Penetration-free thermal interfaces are reconfigurable locations where heat transfer is facilitated from inside the pressurized space 118 to the outside without penetrations through the heat transfer interface, e.g., a pressurized cabin wall thermal barrier.

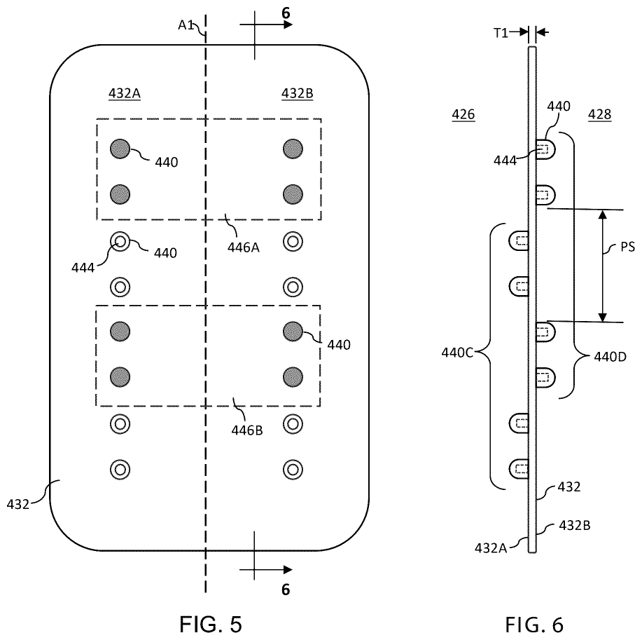

Penetration-free thermal interfaces are described in detail in co-pending, co-owned U.S. Ser. No. 19/045,139 filed Feb. 4, 2025, entitled Penetration-Free Heat Transfer System, which is hereby incorporated herein by reference. Referring now to FIGS. 5 and 6, there is shown a representative embodiment of the thermal barrier 432 of the heat transfer system that can be the penetration-free thermal interfaces 132 as shown in FIG. 1, or any thermal interface of space vehicles described herein. As shown, the thermal barrier can be generally planar with a first, hot side surface 432A and a second, cold side surface 432B. In use, the thermal barriers 432 can be portions of the sides of space vehicles that exhibit curvature. The thermal barrier 432 can be a portion of an outer wall, skin, or panel of the crew cabin of a space vehicle. In an embodiment, the thickness T1 of the thermal barrier 432 can be generally equal to the thickness of the outer wall or outer panel of a space vehicle.

The system central axis A1 can generally divide the thermal barrier into two portions. In the embodiment shown the two portions are symmetric halves. On a first half 432A there is a first row of protrusions having a plurality of protrusions 440 generally equally spaced in a line parallel to the system central axis A1. Likewise, on a second half 432B there is a second row of protrusions having a plurality of protrusions 440 generally equally spaced in a line parallel to the system central axis A. In general, it is not necessary that the protrusions 440 be in rows or otherwise in an ordered pattern. All that is necessary is that at least some of the corresponding holes in the flanges of the heat pipes line up with the protrusions so that fasteners, e.g., bolts or screws, can be disposed through the flanges and fastened to the protrusions via, e.g., internal threads. While bolts are illustrated in the example embodiments herein, it is recognized that any suitable fasteners can be utilized, including blind rivets, quick disconnect fasteners, pressure connections, quarter-turn connections, weldments, as well as glues, adhesives, and magnetic connections.

As shown in FIG. 6, a first portion 440C of the protrusions 440 extend out of the plane of the thermal barrier on the hot side 426 of the thermal barrier 432, and a second portion 440D of the protrusions 440 extend out of the plane of the thermal barrier on the cold side 428 of the thermal barrier 432. In general, the first portion 240C can have the same number, size, and spacing of protrusions 440 as exist on the second portion 440D. However, any number, spacing and pattern of protrusions can be employed as desired for heat conductive requirements of a heat transfer system.

As shown in FIGS. 5 and 6, the protrusions 440 can be configured as bosses welded to the thermal barrier with an interior defining a fastener-receiving opening 444, which can be a blind hole, and which can be internally threaded for receiving threaded fasteners. In the illustrated embodiment, the first portion 440C of protrusions 440 serve as attachment locations for the second heat pipe 420 and the second portion 440D of protrusions 440 can serve as attachment locations for the first heat pipe 410.

The first portion 440C of protrusions 440 and the second portion 440D of protrusions 440 can each be patterned and spaced to accommodate the flanges of the heat pipes. For example, referring to the second portion 440D of protrusions 440, as indicated by the dashed rectangles in FIG. 6, the protrusions 440 are grouped and spaced to accommodate the flanges of the heat pipes. As shown, a first group 446A of protrusions 440 can be spaced in a group suitable for receiving fasteners for a first flange of a heat pipe and a second group 446B of protrusions 440 can be spaced in a group suitable for receiving fasteners for a second flange of a heat pipe (as discussed more fully below). In general, any number of protrusions and any number of groups of protrusions can be employed in the heat transfer system 400. However, for a given number and pattern of protrusions, the groups of protrusions can be spaced a protrusion distance PS apart, as indicated in FIG. 6 for groups 446A and 446B. As discussed below, the separation distance PS accommodates the flanges of the heat pipes mounted to the thermal barrier. In general, the flanges of the heat pipes are “nested” between groups of protrusions in the relatively planar portions of the thermal barrier.

In general, penetration-free thermal interfaces 132 permit thermal heat transfer across an interface, such as the pressurized cabin wall, without potential failure due to penetrations in the cabin wall. The heat can be transferred from a human-safe heat pipe to an external (to the pressurized cabin) thermal radiator, such as radiator 130. In an embodiment, one or more human-safe heat pipes can be in operative heat transfer arrangement with one thermal radiator. In an embodiment, each human-safe heat pipe can be in operative heat transfer arrangement with one or more thermal radiators. Thus, in an embodiment human-safe heat pipes 124 for metabolic heat and/or heat from electronics can mounted to separate penetration free thermal interfaces which go to separate thermal zones. In another embodiment, the electronic human-safe heat pipe 124B can be mounted onto the human-safe heat pipe 124A prior to the human-safe heat pipe 124A mounting to the penetration free thermal interface. In either configuration, the electronics can operate at a higher temperature than that experienced by the astronauts.

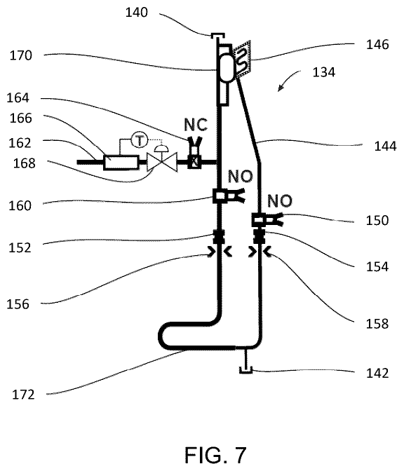

Continuing to refer to FIG. 1, a heat-pipe based thermal control architecture for spacecraft 100 can also incorporate one or more loop heat pipe with a flash evaporator 134. Loop heat pipe flash evaporators are described in more detail in co-pending, co-owned U.S. Ser. No. 17/987,941 filed Nov. 16, 2022, entitled Loop Heat Pipe for Staged Reentry Spacecraft, which is hereby incorporated herein by reference. An example loop heat pipe with flash evaporator system 134 is shown in isolation for descriptive purposes in the schematic view of FIG. 7. The example loop heat pipe with flash evaporator system 134 includes a first fill/drain valve 140 at one end and a second fill/drain valve 142 at the opposite end of the loop heat pipe flash evaporator 134. A continuous loop heat pipe 144 forms a fluid conduit through which a heat pipe fluid traverses therethrough, but which is frangible to be interrupted, for example upon stage separation of the service module from the command module. A first heat exchanger 146 can be positioned proximate the first fill/drain valve 140. The first heat exchanger 146 can be a compensation chamber thermal radiator attached to a compensation chamber and can function as a thermostat for a temperature thermal control system. A first squib valve 150 is normally open (NO) and can be connected to the loop heat pipe with flash evaporator system 134 below the first heat exchanger 146. The first squib valve 150 operates to prevent backflow through the loop heat pipe with flash evaporator system 134 when the first squib valve 150 is closed, e.g., post-separation of the service and command modules.

First and second joints, which can be threaded joints, and in an embodiment are beam seal joints 152, 154 are disposed at the juncture of the service module and command module and are positioned on either side of the loop heat pipe flash evaporator 134. The beam seal joints 152, 154 can enable reuse of capsule modules, if desired. The second beam seal 154 is positioned just below the first squib valve 150 and the first beam seal joint 152 is positioned on the opposite side of the loop heat pipe flash evaporator 134. First and second shape charges 156, 158 are positioned just below the first and second beam seal joints 152, 154. The first and second shape charges 156, 158 are configured to sever the loop heat pipe with flash evaporator system 134 at the beam seal locations 152, 154, respectively when staging, e.g. ejecting a module of the spacecraft. A second squib valve 160 is positioned above the first beam seal joint 152. The second squib valve 160 is a normally open valve that provides for isolation of this path post staging in the same manner as the first squib valve 150.

A pipe extension 162 projects from the loop heat pipe with flash evaporator system 134 above the second squib valve 160. A third squib valve 164 is coupled to the pipe extension 162. The third squib valve 164 is normally closed and operates as a flash evaporator vapor on/off valve after staging. A second heat exchanger 166 is coupled to an electronically controlled valve 168, which can be an electronic proportional control valve, downstream of the third squib valve 164 on the pipe extension 162. The second heat exchanger 166 can, e.g., pick up heat from a first module post staging, and can be in thermal communication with hardware in the module. The electronically controlled valve 168 operates to control the fluid flow rate through the second heat exchanger as a function of a temperature input measured by a temperature sensor T to provide thermostatic regulation of the heat exchanger. The second heat exchanger 166 is a flash evaporator heat exchanger that can be used to cool the spacecraft during reentry into earth orbit. A compensation chamber 170 is positioned between the pipe extension 162 and the first fill/drain valve 140. The compensation chamber 170 holds a heat pipe fluid and is sized to meet reentry cooling requirements of the flash evaporator system after spacecraft staging. A condenser 172 is positioned proximate the lower end of the loop heat pipe with flash evaporator system 134 adjacent the second fill valve 142. The condenser 172 cools the heat pipe fluid in the loop heat pipe with flash evaporator system 134 such that the property phase changes fluid changes phase from a gas to at least partially a liquid.

Referring back to FIG. 1, the lower end of the loop heat pipe (as oriented and viewed in FIG. 1) with flash evaporator system 134 can be positioned proximate a condenser 182. The condenser 182 can cool the heat pipe fluid in the loop heat pipe with flash evaporator system 134 such that the fluid changes phase from a gas to at least partially a liquid. Additionally, the loop heat pipe flash evaporator 134 can be joined in thermally conductive contact with ammonia (NH₃) heat pipes 180 for further heat removal. The ammonia heat pipes 180 can be embedded in one or more thermal radiators 181 on the service module, as described below. In an embodiment, as illustrated in FIG. 1, the condenser 183 and any related heat transfer components can be configured in the service module 114. In an embodiment, the loop heat pipe of the loop heat pipe with flash evaporator system 134 can be operatively joined for thermal dissipation utilizing a radiator, which can be a white painted belly-band radiator, for example, an isogrid, metal plate, carbon-carbon, or honeycomb core radiator, to facilitate sink temperatures in relatively cold environments. In an embodiment, the loop heat pipe with flash evaporator system 134 can also be thermally coupled to constant conductance heat pipes to couple a long or narrow radiator 181. In an embodiment, the ammonia heat pipes 180 are constant conductance heat pipes. In the illustrated configuration, the loop heat pipe 134 of FIG. 7 can be frangible, i.e., it can be severed by the shaped charges 156 and 158 to form a flash evaporator circuit that provides continued passive thermal control in the command module 116 after the service module has been jettisoned from the spacecraft.

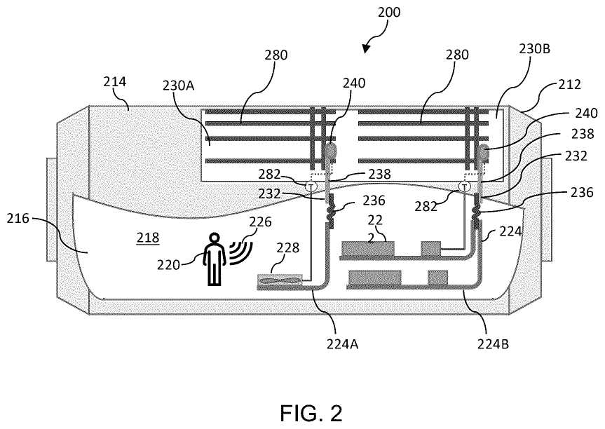

Referring to FIG. 2, there is shown another example embodiment of a heat-pipe based thermal control architecture for a space station module 200, which is described herein as a passive thermal system that includes heat transfer apparatuses and a space station module 212. The space station module 212 can have a module exterior and an interior crew cabin 216 which is a pressurized space 218 that can house persons 220 and equipment 222, such as electronics. The people and equipment in the pressurized space 218 of the crew cabin 216 can produce heat inside the pressurized space 218 that can be problematic if the temperature in the pressurized space 218 exceeds certain thresholds. A heat-pipe based thermal control architecture for a space station module 200 is described below, without excess duplication of the description of components having the same description and function.

Inside the pressurized space 218 at least one human-safe heat pipe 224 can aid in heat transfer from both metabolic heat from persons 220, and heat from equipment 222. The human-safe heat pipe 224 can be identical to the human-safe heat pipe 124 described above. As described above, the human-safe heat pipe 224 can optionally include an evacuated dump tank at one end of the heat pipe with a rupture disk separating the dump tank from the active portion of the heat pipe. In the anomalous event that the heat pipe overpressures, the burst disk can rupture to provide additional volume to the heat pipe to prevent a dangerous rupture which harm people nearby.

A plurality of human-safe heat pipes 224 can be utilized for dedicated thermal purposes. For metabolic heat 226 from persons 220 in the crew cabin 216, a cabin fan and heat sink 228 can transfer heat into a portion of a first human-safe heat pipe 224A. The cabin fan can be any of known cabin fans suitable for part of a ventilation system in manned spacecraft. The heat sink can be any of known suitable heat sinks and can be a heat sink thermally coupled to the first human-safe heat pipe 224A. Equipment 222, including electronics, which in general can withstand higher temperatures than that desired for cabin air, can be mounted in heat-conductive relationship to a second human-safe heat pipe 224B. Each of the plurality of heat pipes 224 can be mounted directly, or via a flexible heat pipe 236, to one or more penetration free thermal interfaces 232. A suitable flexible heat pipe 236 can include both axial and radial corrugations, the axial corrugations providing for capillary fluid flow and the radial corrugations providing for bending flexibility. As described above, the penetration-free thermal interfaces 232 permit thermal heat transfer across an interface, such as the pressurized cabin wall, without potential failure due to penetrations in the cabin wall.

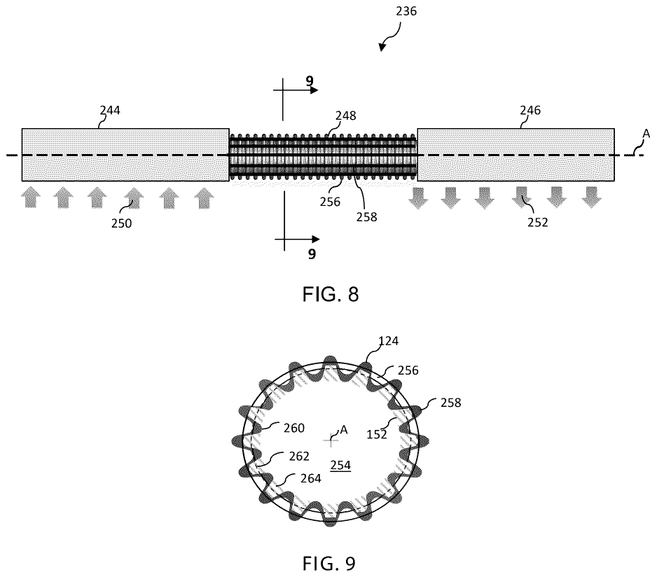

An example flexible heat pipe 236 is described in co-owned, co-pending U.S. Ser. No. 19/045,161 filed Feb. 4, 2025, entitled Flexible Heat Pipe, which is hereby incorporated herein by reference. Referring to FIG. 8 there is shown a representative flexible heat pipe 236. The flexible heat pipe 236 has an evaporator portion 244 and a condenser portion 246 separated by a flexible section 248. Heat 250 to be moved is transferred into the flexible heat pipe 236 in the evaporator portion 244 to cause a phase change in an internally disposed working fluid, e.g., vaporization to a gas phase, within the flexible heat pipe 236. Heat 252 to be released exits at the condenser portion 246 where the working fluid undergoes the reverse phase change, e.g., condensation back into a fluid. The fluid is then transported back, such as wicking by capillary transport, to the evaporator portion of the flexible heat pipe 236 to absorb additional heat. In the flexible heat pipe 236, the evaporator portion 244 and the condenser portion 246 can each be made of rigid metal and can include structural characteristics common to known rigid heat pipe configurations. In an example embodiment, the flexible heat pipe 236 can be generally cylindrically shaped and extend longitudinally about an imaginary central axis A.

As indicated in FIG. 8, and in the cross-section shown in FIG. 9, the flexible portion 248 of the flexible heat pipe 236 can be flexible and provide for the functional equivalent of axial ridges defining axial grooves in the interior 254 of the flexible heat pipe 236. In an embodiment, the flexible portion is a flexible metal pipe or hose (the terms being interchangeable and synonymous for this disclosure). As also shown in FIG. 8, the flexible portion 248 is a flexible metal hose with both radial corrugations 256 and axial corrugations 258. The radial corrugations 256 provide for bending flexibility of the flexible heat pipe 236. The axial corrugations 258 define the functional equivalent of the axial “ridge and groove” configuration of the evaporator and condenser portions described above. Internal corrugation peaks 260 define the functional equivalent of ridges that define internal valleys 262 that define the functional equivalent of grooves in the rigid portions of the flexible heat pipe 236. Capillary fluid transport indicated by the shading at 264 transports fluid from the condenser portion of the heat pipe to the evaporator portion.

Heat can be transferred from a human-safe heat pipe to one or more external (to the pressurized cabin) thermal radiators 230. In the example shown in FIG. 2, two radiators are shown, a first radiator 230A and a second radiator 230B. In an embodiment, one or more human-safe heat pipes can be in operative heat transfer arrangement with each thermal radiator. In an embodiment, each human-safe heat pipe can be in operative heat transfer arrangement with one or more thermal radiators. Thus, in an embodiment, metabolic and electronics human-safe heat pipes 224 can mounted to separate penetration free thermal interfaces which go to separate metabolic and electronic radiator thermal zones. As shown in the example embodiment of FIG. 2, the first human safe heat pipe 224A can be thermally coupled to the first radiator 230A via a flexible heat pipe 236 joined at a penetration-free thermal interface 232 permit thermal heat transfer across the interface to a thermostatic thermomodulating heat pipe, 238. A thermostatic thermomodulating heat pipe can be similar to a variable conductance heat pipe that is designed such that if the radiator temperature becomes warmer than the cabin temperature (such as due to flying in hot environments like across the sunlit moon in low lunar orbit), the gas in the thermostatic thermomodulating heat pipe can shift to the other side of the heat pipe and block heat transfer. In such a situation, heat can be shunted to radiators facing in cooler directions or store heat in the space vehicle or a phase change material.

Referring again to FIG. 2, the thermostatic thermomodulating conductance heat pipe 238 can utilize a reservoir 240 of non-condensable gas to dynamically adjust its heat transfer capability, allowing it to maintain a relatively constant temperature even when the heat load or sink conditions change significantly, as well as cold environment shutdown. The thermostatic thermomodulating conductance heat pipe 238 can operate similarly to a variable conductance heat pipe but is configured to be thermally coupled to interior heat pipes and external radiators to permit gas to move to a condenser in situations where the external radiator is hotter than the internal electronics and/or cabin environment. These capabilities render a thermostatic thermomodulating heat pipe 238 useful in spacecraft thermal control systems due to its ability to adapt to varying heat loads in space environments. The thermostatic thermomodulating heat pipes 238 can be thermally coupled to a constant conductance heat pipe 280 to spread heat across their respective radiators 230. In an embodiment, first radiator 230A can be a cool radiator zone, and second radiator 230B can be a warm radiator zone. For each, temperature and/or temperature changes and/or temperature differences can be monitored, detected, and/or controlled via a temperature gauge 282 for each internal to external heat pipe thermal flow path.

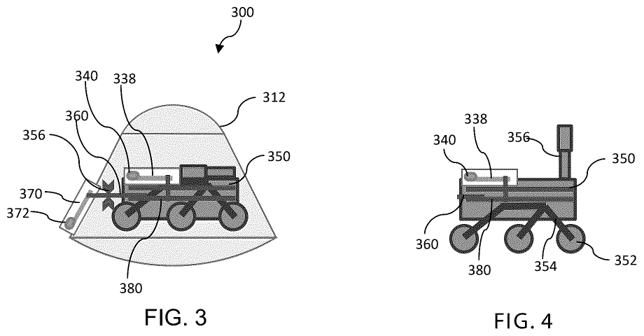

Referring to FIGS. 3 and 4, there is shown another example embodiment of a heat-pipe based thermal control architecture for a surface rover 300, which is described herein as a passive thermal system that includes heat transfer apparatuses and at least one surface rover 350 that can be transported inside a space vehicle 312. The surface rover 350 can have components common to surface rovers, including a plurality of wheels 352, each mounted to suitable suspension and power components 354 for powered mobility on surfaces. The surface rover 350 can have one or more hinged foldable components, such as camera probe 356 that can be folded about a hinged joint for compact stowage as depicted in FIG. 3 and deployed for use as depicted in FIG. 4. A heat-pipe based thermal control architecture for a surface rover 300 is described below, without duplication of the description of components that were described above.

A heat-pipe based thermal control architecture for a surface rover 300 can include one or more ammonia heat pipes 380 thermally coupled to heat sources, such as electronic equipment on the surface rover 300. The ammonia heat pipes can be thermally coupled to one or more rover-mounted thermostatic thermomodulating heat pipes 238. The thermostatic thermomodulating heat pipe 338 can utilize a reservoir 3 of non-condensable gas to dynamically adjust its heat transfer capability, allowing it to maintain a relatively constant temperature even when the heat load or sink conditions change significantly, as well as cold environment shutdown. The thermostatic thermomodulating heat pipe 338 can operate similarly to a variable conductance heat pipe but is configured to be thermally coupled to interior heat pipes and external radiators to permit gas to move to a condenser in situations where the external radiator is hotter than the internal electronics of the rover 312 The rover-mounted thermostatic thermomodulating heat pipe 338 can utilize a reservoir 340 of non-condensable gas to dynamically adjust its heat transfer capability, allowing it to maintain a relatively constant temperature even when the heat load or sink conditions change significantly, as well as cold environment shutdown.

As shown in FIG. 3, the ammonia heat pipe(s) 380 can also be thermally coupled to a frangible heat pipe 360 coupled to one or more space vehicle-mounted variable thermostatic thermomodulating pipes 370. A frangible heat pipe is a heat pipe having at least one sealing joint that can be destructively removed to split the heat pipe into two parts as part of a spacecraft staging event. The frangible heat pipe enables space missions requiring heat transport requiring a staging interface across a heat transport path to choose a heat pipe network thermal control system architecture. The space vehicle-mounted thermostatic thermomodulating heat pipe 370 can utilize a reservoir 372 of non-condensable gas to dynamically adjust its heat transfer capability, allowing it to maintain a relatively constant temperature even when the heat load or sink conditions change significantly, as well as cold environment shutdown. One or more shape charges 356 can be positioned and configured to sever the rover heat pipes from the space vehicle heat pipes via the frangible heat pipe 360.

All of the embodiments of heat-pipe based thermal control architectures disclosed herein benefit from heat transfer and thermal stability via heat pipes with no moving solid parts. The reduction or elimination of moving solid parts increases reliability in use. Further, the various heat pipes disclosed can be modularly arranged in optimal heat transfer configuration utilizing passively pumped systems. For example, the flash evaporation components of the flash evaporation system 134 as shown in FIG. 1 can be mounted relatively higher (as viewed in the orientation of FIG. 1) than the human-safe heat pipes 124 to ensure heat flow is upward. In general, the various heat pipes of the disclosure can provide for steady state cooling on-orbit and transient when needed, such as during spacecraft reentry into earth's atmosphere. Further, the frangible heat pipe components permit transient mechanical operations, including staging of space flight components via shape charges that can sever portions of the heat pipe system. Still further, heat-pipe based thermal control architectures benefit by utilizing individual heat pipes as described, each optimally accomplishing a predetermined heat transfer function in its environment.

Having described the disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure. For example, any or all of the disclosed heat pipes can include overpressure relief for human safety.

All documents cited in the Detailed Description of the Disclosure are, in relevant part, incorporated herein by reference; the citation of any document is not to be construed as an admission that it is prior art with respect to the present disclosure. To the extent that any meaning or definition of a term in this written document conflicts with any meaning or definition of the term in a document incorporated by reference, the meaning or definition assigned to the term in this written document shall govern.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A passive thermal control system for spacecraft, comprising,
a spacecraft, the spacecraft including a service module and a command module, wherein the command module comprises a pressurized space;
a first heat pipe disposed inside the pressurized space, the first heat pipe being thermally coupled to a second heat pipe outside the pressurized space; and
a third heat pipe thermally coupled to the second heat pipe at the service module.

2. The passive thermal control system for spacecraft of claim 1, wherein the first heat pipe is a human safe heat pipe.

3. The passive thermal control system for spacecraft of claim 1, wherein the first heat pipe comprises an extruded grooved aluminum envelope with n-Perfluorohexane (nPFH), as a working fluid.

4. The passive thermal control system for spacecraft of claim 1, wherein the second heat pipe is a loop heat pipe with a flash evaporator.

5. The passive thermal control system for spacecraft of claim 1, wherein the second heat pipe is a loop heat pipe with a flash evaporator, the second heat pipe further comprising two shape charges for frangibly severing the second heat pipe in the command module.

6. The passive thermal control system for spacecraft of claim 1, wherein the third heat pipe is an ammonia heat pipe.

7. The passive thermal control system for spacecraft of claim 1, wherein the pressurized space comprises two first heat pipes, the two first heat pipes being thermally coupled to the second heat pipe, and wherein one of the two first heat pipes is thermally coupled to heat-generating equipment.

8. The passive thermal control system for spacecraft of claim 1, wherein the third heat pipe is an ammonia heat pipe and further comprising a radiator thermally coupled to the ammonia heat pipe.

9. The passive thermal control system for spacecraft of claim 1, wherein the first heat pipe is thermally coupled to the second heat pipe via a penetration-free thermal interface.

10. A passive thermal control system for spacecraft, comprising,
a spacecraft, the spacecraft including an interior crew cabin; and
a first heat pipe disposed inside the crew cabin, the first heat pipe being thermally coupled to a flexible second heat pipe that is thermally coupled to a third heat pipe outside the crew cabin.

11. The passive thermal control system for spacecraft of claim 10, wherein the first heat pipe is a human safe heat pipe.

12. The passive thermal control system for spacecraft of claim 10, wherein the first heat pipe comprises an extruded grooved aluminum envelope with n-Perfluorohexane (nPFH), as a working fluid.

13. The passive thermal control system for spacecraft of claim 10, wherein the third heat pipe is a loop heat pipe with a flash evaporator.

14. The passive thermal control system for spacecraft of claim 10, wherein the third heat pipe is thermally coupled to a fourth heat pipe which is an ammonia heat pipe.

15. The passive thermal control system for spacecraft of claim 10, wherein the third heat pipe is an ammonia heat pipe and further comprising a radiator thermally coupled to the ammonia heat pipe.

16. The passive thermal control system for spacecraft of claim 10, wherein the third heat pipe is a flexible heat pipe.

17. A passive thermal control system for spacecraft, comprising,
a spacecraft, the spacecraft including an interior crew cabin; and
a first heat pipe disposed inside the crew cabin, the first heat pipe being thermally coupled to a flexible second heat pipe that is thermally coupled to a third heat pipe outside the crew cabin.

18. The passive thermal control system for spacecraft of claim 17, wherein the first heat pipe is a human safe heat pipe.

19. The passive thermal control system for spacecraft of claim 17, wherein the first heat pipe comprises an extruded grooved aluminum envelope with n-Perfluorohexane (nPFH), as a working fluid.

20. The passive thermal control system for spacecraft of claim 17, wherein the third heat pipe is a loop heat pipe with a flash evaporator.
